(19) United States
(12) Patent Application Publication
(10) Pub. No.: US 2026/0322444 A1
(43) Pub. Date: Oct. 15, 2026

(54) HIERARCHICAL CHANNEL MEASUREMENT RESOURCE BEAM SHAPE INDICATION FOR UE BASED PREDICTIVE BEAM MEASUREMENT

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/100,387

(22) PCT Filed: Sep. 28, 2022
(86) PCT No.: PCT/CN2022/121976

§ 371 Date: Jan. 31, 2025

(51) Int. Cl. H04B 7/06; H04W 72/232

(52) U.S. Cl. CPC H04B 7/0626; H04B 7/0617; H04W 72/232

(57) ABSTRACT

A user equipment (UE) may obtain a configuration of one or more channel measurement resource (CMR) sets and virtual resources, wherein each of the one or more CMR sets has a unique measurement periodicity and the virtual resources are independent of any transmission of a reference signal thereon. The UE may measure channel characteristics associated with the one or more CMR sets based on beam shape information and one or more of the unique measurement periodicities. The UE may generate predicted channel characteristics associated with at least one of the virtual resources based on the beam shape information and the channel characteristics. The UE may report channel state information (CSI) comprising the channel characteristics and the predicted channel characteristics.

### TECHNICAL FIELD

The present disclosure relates to wireless communications, and more particularly to hierarchical channel measurement resource (CMR) beam shape indication for user equipment (UE) based predictive beam measurement.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to a method of wireless communication for a user equipment (UE), including obtaining a configuration of one or more channel measurement resource (CMR) sets and virtual resources, wherein each of the one or more CMR sets has a unique measurement periodicity and the virtual resources are independent of any transmission of a reference signal thereon; measuring channel characteristics associated with the one or more CMR sets based on beam shape information and one or more of the unique measurement periodicities; generating predicted channel characteristics associated with at least one of the virtual resources based on the beam shape information and the channel characteristics; and reporting channel state information (CSI) comprising the channel characteristics and the predicted channel characteristics.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

One innovative aspect of the subject matter described in this disclosure can be implemented in a method of wireless communication at a base station (BS) including: configuring a UE with one or more CMR sets and virtual resources, wherein each of the one or more CMR sets has a unique measurement periodicity and the virtual resources are independent of any transmission of a reference signal thereon; indicating beam shape information for the one or more CMR sets and the virtual resources; and obtaining CSI that includes measured channel characteristics associated with the one or more CMR sets and predicted channel characteristics associated with the virtual resources, wherein the predicted channel characteristics are based on the beam shape information and the measured channel characteristics

The present disclosure also provides an apparatus (e.g., a BS) including a memory storing computer-executable instructions and at least one processor configured to execute the computer-executable instructions to perform the above method, an apparatus including means for performing the above method, and a non-transitory computer-readable medium storing computer-executable instructions for performing the above method.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communications system and an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 shows a diagram illustrating an example disaggregated base station architecture.

FIG. 5 is a diagram illustrating an example of predicting characteristics of a second set of beams from characteristics of a first set of beams.

FIG. 6 is a diagram illustrating an example of predicting a best beam from characteristics of a first set of beams.

FIG. 7 is a diagram illustrating an example of joint space domain and time domain prediction of beam and/or channel characteristics.

FIG. 8 is a diagram of an association between various reference signal beam shapes and measurement resources.

FIG. 9 is a diagram of indicating a dynamic beam shape associated with the resources using codepoints.

FIG. 10 is a diagram of a configuration for a compact indication of beam shape information.

FIG. 11 is a diagram of associating beam shape information for a set of beams with resources based on active transmission configuration indication (TCI) states.

FIG. 12 is a message diagram illustrating example messages between a base station and a UE.

FIG. 13 is a conceptual data flow diagram illustrating the data flow between different means/components in an example base station.

FIG. 14 is a conceptual data flow diagram illustrating the data flow between different means/components in an example UE.

FIG. 15 is a flowchart of an example method for a UE to perform beam failure detection procedures using beam failure prediction.

FIG. 16 is a flowchart of an example method for a base station to control beam failure prediction at a UE.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In wireless communications, beamforming may be used to compensate for power loss in communication between a transmitter and receiver. For example, in millimeter wave (mmW or mm Wave) communications, the frequency may be relatively high compared to conventional communication channels and signal attenuation may be relatively large. However, due to the uncertain nature of a wireless environment and unexpected blocking, a beam may be vulnerable to beam failure. Techniques for beam management seek to select appropriate beams for communication and quickly select a different beam in the event of beam failure. For example, a UE may measure channel characteristics such as Layer 1 (L1) reference signal received power (RSRP) or L1 signal to interference plus noise ratio (SINR) for various beams. The UE may report the channel characteristics to the base station to control the beams used for communication.

In some implementations, three levels of beam management are used with various selection processes. For example, a first level P1, is used to enable UE measurement of different (wide) TRP Tx beams to support selection of TRP Tx beams or UE Rx beams. Beamforming at the TRP typically includes an intra/inter-TRP Tx beam sweep from a set of different beams. Beamforming at the UE typically includes a UE Rx beam sweep from a set of different beams. For example, the UE identifies and reports the best SSB/CSI-RS together with a corresponding L1-RSRP (including also identifying the associated Rx beam), based on measurements of an SSB Burst Set or a P-CSI-RS Resource Set. A second level P2 is used to enable UE measurement on different (narrow) TRP Tx beams to possibly change inter/intra-TRP Tx beams. P2 processing may be performed on a possibly smaller set of beams for beam refinement than in P1. For example, a base station may beamform some UE-specific CSI-RS resources, which are narrow beams super-positioned w/the SSB that the UE reported in P1. The UE may further identify and report the best CSI-RS resource together a corresponding L1-RSRP (including also identifying the associated Rx beam), based on measurements of the CSI-RS resources. In some implementations, P2 can be considered a special case of P1. P3 is used to enable UE measurement on the same (narrow) TRP Tx beam to change UE Rx beam in the case UE uses beamforming.

Channel measurements for beam management may consume resources such as time-frequency resources for reference signals and UE processing power for performing measurements. In order to achieve acceptable performance, greater power or overhead is used for measurements and/or reporting. Meanwhile, beam accuracy may be limited due to restrictions on power or overhead, and latency or throughput may be impacted by beam switching in the event of beam failure.

One approach to improve beam management is the user of machine-learning or artificial intelligence. For example, machine-learning or artificial intelligence may be used in beam management to predict beams in the time domain and/or the spatial domain for overhead and latency reduction. Such prediction offers the possibility to reduce power or overhead and/or improve accuracy, latency, or throughput. For example, prediction of non-measured beam qualities may result in lower power or overhead or may result in better accuracy. In some cases, machine-learning or artificial intelligence may be able to predict future beam blockage, which may improve latency or throughput. Beam prediction, however, is a highly non-linear problem. For example, predicting future transmission beam qualities may depend on movement speed or trajectory of the UE, receive beams used, interference, etc. Beam prediction is difficult to model via conventional statistical signaling processing methods The use of machine-learning or artificial intelligence introduces new challenges such as model training, model deployment, model inference, model monitoring, and model updating. For example, machine-learning or artificial intelligence may include a tradeoff between performance and UE power. For example, prediction of future DL-Tx beam qualities may be based on UE measurements. Therefore, UE prediction may outperform base station prediction, but consume greater power at the UE. As another example, training models based on real-world data may involve greater UE computation and buffering efforts.

In an aspect, the present disclosure provides techniques for UE based predictive beam management utilizing beam shape information to generate predictive channel characteristics. For example, a UE may obtain a configuration of one or more channel measurement resource (CMR) sets and virtual resources. A CMR set may define resources for monitoring on which the base station transmits a reference signal on a beam. The UE may receive the reference signal and determine channel characteristics associated with the CMR set. In some implementations, multiple CMR sets may be configured, and each CMR set may have a unique periodicity. Virtual resources may define resources that are independent of a reference signal thereon. For example, the UE may predict channel characteristics of a virtual resource based on beam shape information and the channel characteristics associated with a CMR set. The UE may report channel state information (CSI) comprising a combination of measured channel characteristics and predicted channel characteristics. The base station may manage beams based on the reported CSI.

Particular implementations of the subject matter described in this disclosure can be implemented to realize one or more of the following potential advantages. The UE may conserve power by limiting actual measurements of reference signals while reporting CSI for various beams. In some implementations, the beam shape information or association between beams and the CMR sets may be dynamically updated such that the UE provides relevant CSI for beam management.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media excludes transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

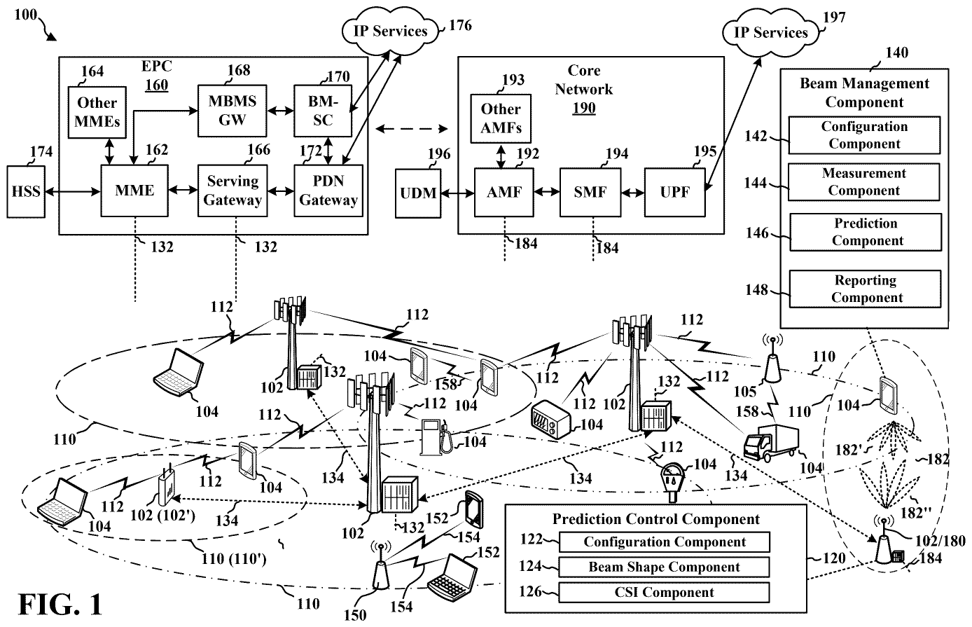

FIG. 1 is a diagram illustrating an example of a wireless communications system and an access network 100. The wireless communications system (also referred to as a wireless wide area network (WWAN)) includes base stations 102, UEs 104, relay devices 105, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU). The base stations 102 may be generically referred to as network entities.

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some implementations, one or more of the UEs 104 may include a beam management component 140 configured to report channel characteristics for beam management. The beam management component 140 may include a configuration component 142 configured to obtain a configuration of one or more CMR sets and virtual resources. Each of the one or more CMR sets has a unique measurement periodicity and the virtual resources are independent of any transmission of a reference signal thereon. The beam management component 140 may include a measurement component 144 configured to measure channel characteristics associated with the one or more CMR sets based on beam shape information and one or more of the unique measurement periodicities. The beam management component 140 may include a prediction component 146 configured to generate predicted channel characteristics associated with at least one of the virtual resources based on the beam shape information and the channel characteristics. The beam management component 140 may include a reporting component 148 configured to report CSI comprising the channel characteristics and the predicted channel characteristics.

In some implementations, one or more of the base stations 102 may include a prediction control component 120 configured to select beams for beam management. The prediction control component 120 may include a configuration component 122 configured to configure a UE 104 with one or more CMR sets and virtual resources. Each of the one or more CMR sets has a unique measurement periodicity and the one or more virtual resources are independent of any transmission of a reference signal thereon. The prediction control component 120 may include a beam shape component 124 configured to indicate beam shape information for the one or more CMR sets and the virtual resources. The prediction control component 120 may include a CSI component 126 configured to obtain CSI that includes measured channel characteristics associated with the one or more CMR sets and predicted channel characteristics associated with at least one of the virtual resources. The predicted channel characteristics are based on the beam shape information and the measured channel characteristics.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

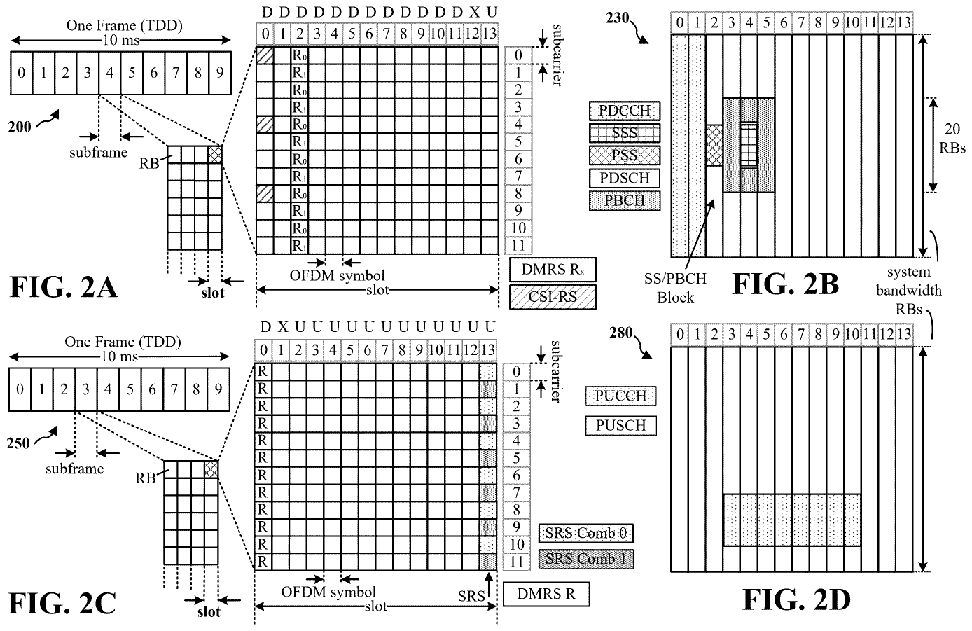

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used.

The UE may transmit sounding reference signals (SRS). An SRS resource set configuration may define resources for SRS transmission. For example, as illustrated, an SRS configuration may specify that SRS may be transmitted in the last symbol of a subframe. The SRS may have a comb structure, and a UE may transmit SRS on one comb for each SRS port. The SRS may be used by a base station for channel quality estimation to enable frequency-dependent scheduling on the UL. The SRS may also be used for channel estimation to select a precoder for downlink MIMO.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

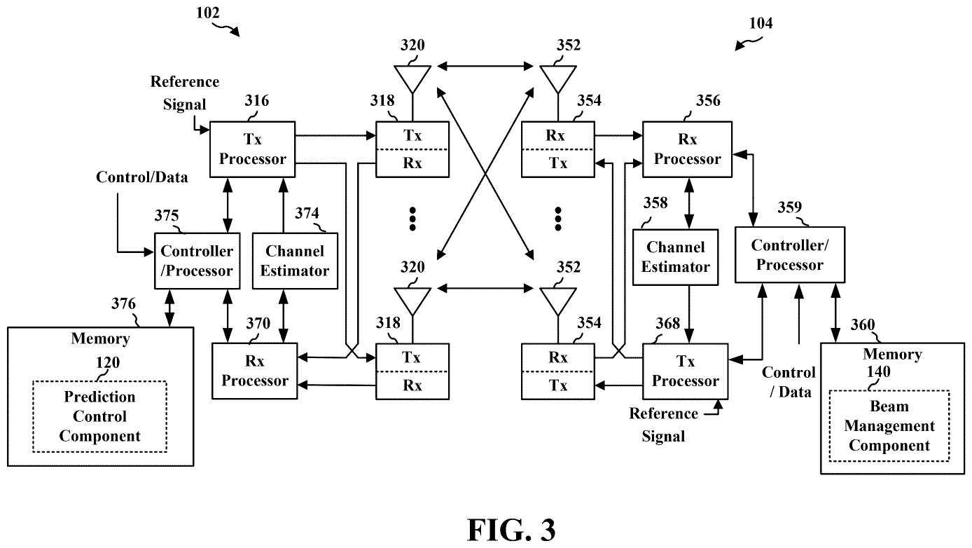

FIG. 3 is a diagram of an example of a base station 102 and a UE 104 in an access network. The UE 104 may be an example of a receiving device. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 104. Each spatial stream may be provided to a different antenna 320 via a separate transmitter 318Tx. Each transmitter 318Tx may modulate an RF carrier with a respective spatial stream for transmission.

At the UE 104, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 104. If multiple spatial streams are destined for the UE 104, they may be combined by the Rx processor 356 into a single OFDM symbol stream. The Rx processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are decoded and deinterleaved to recover the data and control signals that were originally transmitted by the base station 102 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 102, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 102 in a manner similar to that described in connection with the receiver function at the UE 104. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK or NACK protocol to support HARQ operations.

At least one of the Tx processor 368, the Rx processor 356, and the controller/processor 359 may be configured to perform aspects in connection with the beam management component 140 of FIG. 1. For example, the memory 360 may include executable instructions defining the beam management component 140. The Tx processor 368, the Rx processor 356, and/or the controller/processor 359 may be configured to execute the beam management component 140.

At least one of the Tx processor 316, the Rx processor 370, and the controller/processor 375 may be configured to perform aspects in connection with the prediction control component 120 of FIG. 1. For example, the memory 376 may include executable instructions defining the prediction control component 120. The Tx processor 316, the Rx processor 370, and/or the controller/processor 375 may be configured to execute the prediction control component 120.

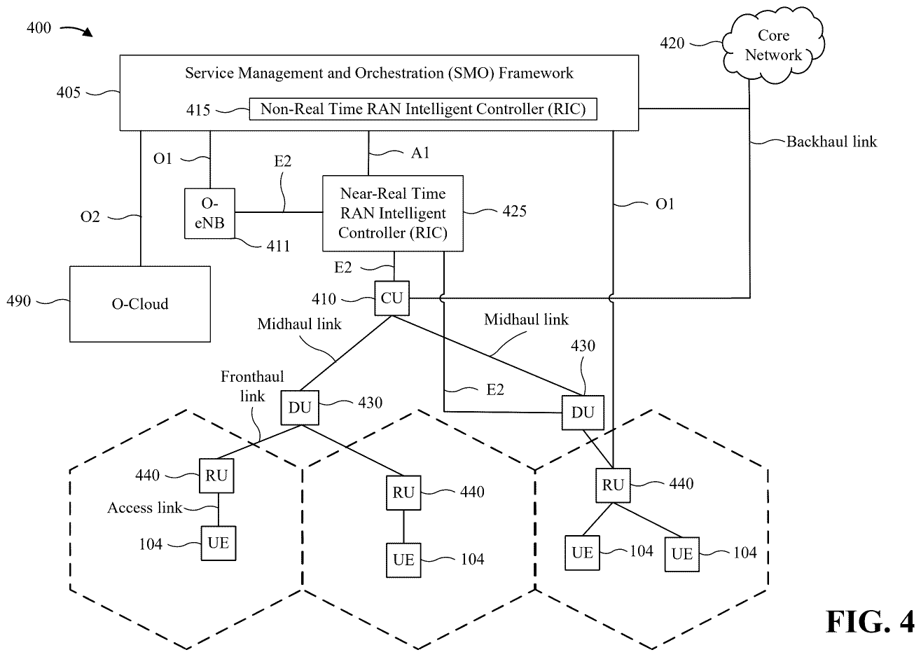

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUS) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit—User Plane (CU-UP)), control plane functionality (i.e., Central Unit—Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the El interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

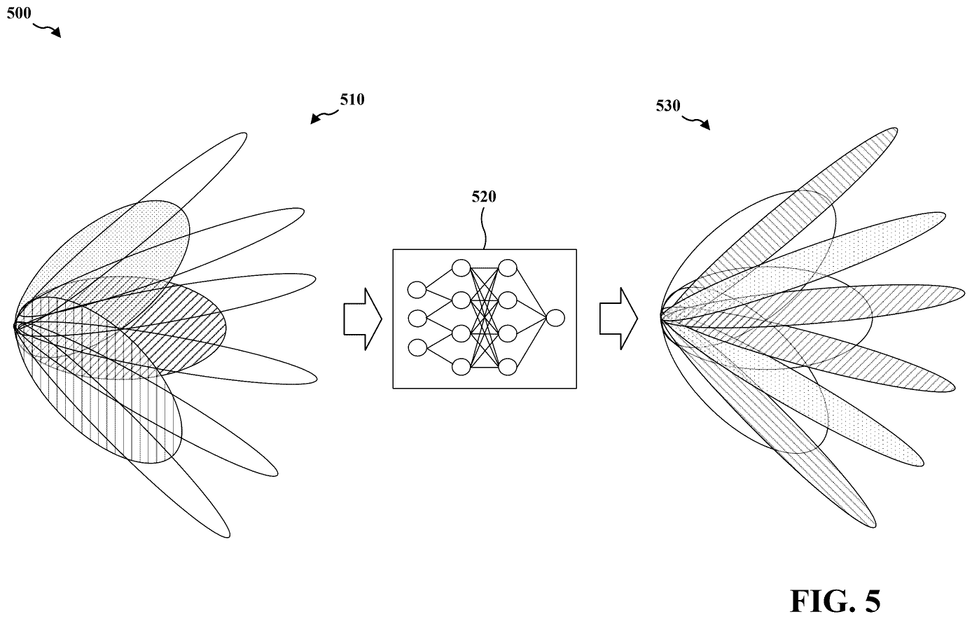

FIG. 5 is a diagram 500 illustrating an example of predicting characteristics of a second set of beams 530 from characteristics of a first set of beams 510. For example, a UE 104 may measure the first set of beams 510, which may be configured as a CMR set. As illustrated, the first set of beams 510 may include relatively wide beams compared to the second set of beams 530. For instance, a codebook may define the first set of beams 510 and the second set of beams 530 as a hierarchical beam structure. That is, each beam of the first set of beams 510 may cover multiple narrower beams of the second set of beams 530.

In an aspect, a machine-learning or artificial intelligence model 520 may predict the channel characteristics of the second set of beams 530 based on the channel characteristics of the first set of beams 510. For example, the model 520 may be a neural network trained on measured or synthesized training data including beam measurements (e.g., L1 RSRP or L1 SINR) for two layers of hierarchical beams. In an aspect, beam shape information may define which beams of the second set of beams 530 are covered by the beams of the first set of beams 510. For example, beam shape information may define a beam pointing direction, an angular-specific beamforming gain, or an angular difference from a boresight direction for a specified beamwidth. During inference, the UE 104 may select which beams of the first set of beams 510 to input to the model 520. The UE 104 may map the output of the model 520 to individual beams of the second set of beams 530. For instance, the UE 104 may use the model 520 to predict the characteristics of the second set of beams 530, which may correspond to virtual resources.

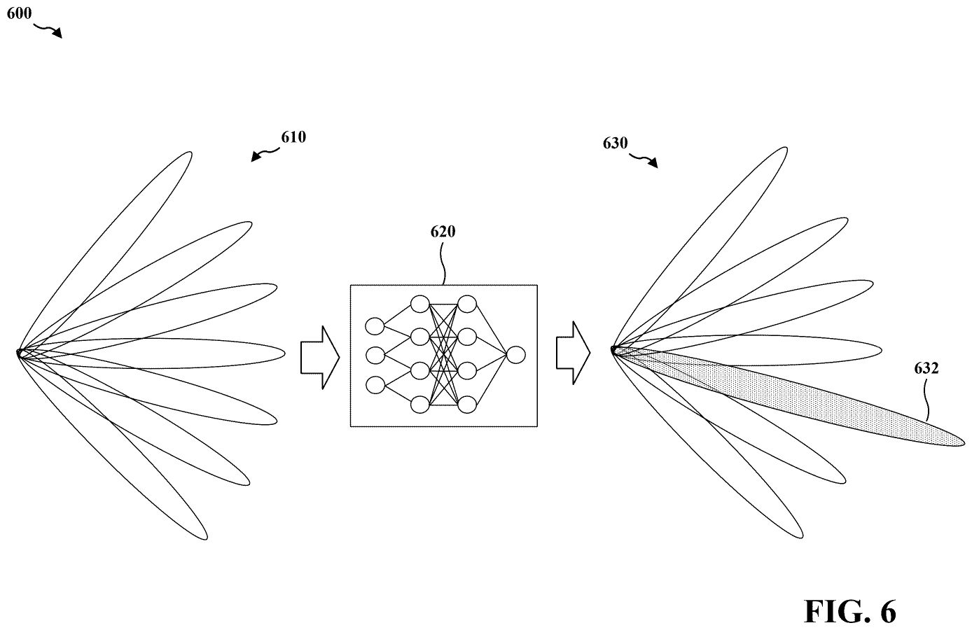

FIG. 6 is a diagram 600 illustrating an example of predicting a best beam 632 from characteristics of a first set of beams 610. For example, a UE 104 may measure the characteristics of the first set of beams 610. A machine-learning or artificial intelligence model 620 may be trained to predict characteristics of a single beam based on the characteristics of the first set of beams 610. For example, the model 620 may predict a beam pointing direction of the best beam 632, an angle of departure (AoD), an angle of arrival (AoA), an angular-specific beamforming gain of the best beam 632, or an angular difference from a boresight direction for a beamwidth of the best beam 632. Prediction of the best beam 632 may be referred to as non-codebook based space domain prediction. In some implementations, a UE 104 may indicate the best beam 632 as a closest beam in a second set of beams 630.

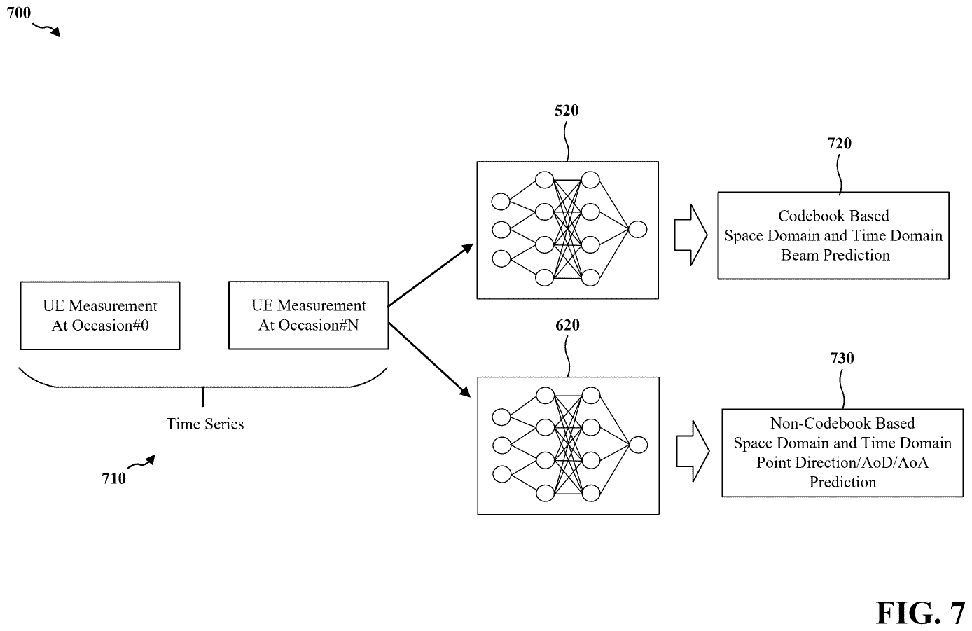

FIG. 7 is a diagram 700 illustrating an example of joint space domain and time domain prediction of beam and/or channel characteristics. The UE 104 may measure a first set of beams (e.g., first set of beams 510 or 610) over a period of time to generate a time series 710. At block 720, a model 520 for codebook based SD selection may be used to predict channel characteristics of the second set of beams 530 at a future point in time. At block 730, a model 620 for non-codebook based SD prediction may be used to predict a best beam at a future point in time.

Machine-learning or artificial intelligence based beam prediction may present several technical problems in actual implementation. For example, a base station and a UE may need to determine which beams are to be measured and which beams are to be predicted. Efficient resource usage may involve associating different beams with configured CMR sets, so another technical problem is how to efficiently indicate associations between configured CMR sets and beam shape information. Current measurement and reporting techniques may not support selective transmission and monitoring and/or virtual resources. In particular, Release-17 of the 3GPP 5G NR standards does not allow joint consideration of CMR sets with different periodicities. That is, each CSI report is only for a specific set of configured resources. The current standards do not provide procedures for dynamically updating beam shapes to facilitate selective transmission and monitoring of beams and/or virtual resources.

A base station may beamform different CSI-RS resources towards different directions that a UE may move around. That is, as the UE moves around, the UE may experience different channel conditions for each beam. For the beam directions that currently provide good channel gains towards the UE, it makes sense to transmit the corresponding CSI-RS resources most frequently, to track them more closely for more accurate/real-time L1-RSRPs. For the beam directions that currently do not provide the best channel gains, the base station could transmit them less frequently, and when necessary, the UE can help with predicting L1-RSRPs regarding these directions, for the time domain occasions that are not transmitted. Selective transmission and/or monitoring of the CSI-RS may reduce system-level CSI-RS overhead consumption and UE power consumption for measuring such beams. Selective transmission and/or monitoring may also help reduce RS overhead consumption for preparation of beam-switch. For the beam directions that currently may provide very limited channel gains, the base station could refrain from transmitting beams via CSI-RS, while the UE can help with predicting L1-RSRPs regarding these directions. For example, the UE may consider the resources on which no beam is transmitted to be virtual resources. The use of virtual resources would reduce system-level CSI-RS overhead consumption and UE power consumption for measuring such beams assigned to virtual resources. Use of virtual resources may also help reduce RS overhead consumption for preparation of beam-switch. Such beam directions associated with different CSI-RS resources w/different periodicities (or even not transmitted), may be dynamically updated based on a trajectory of UE movement or real-time L1-RSRP measurement/prediction such that UE-based beam prediction could be carried out based on such information updates.

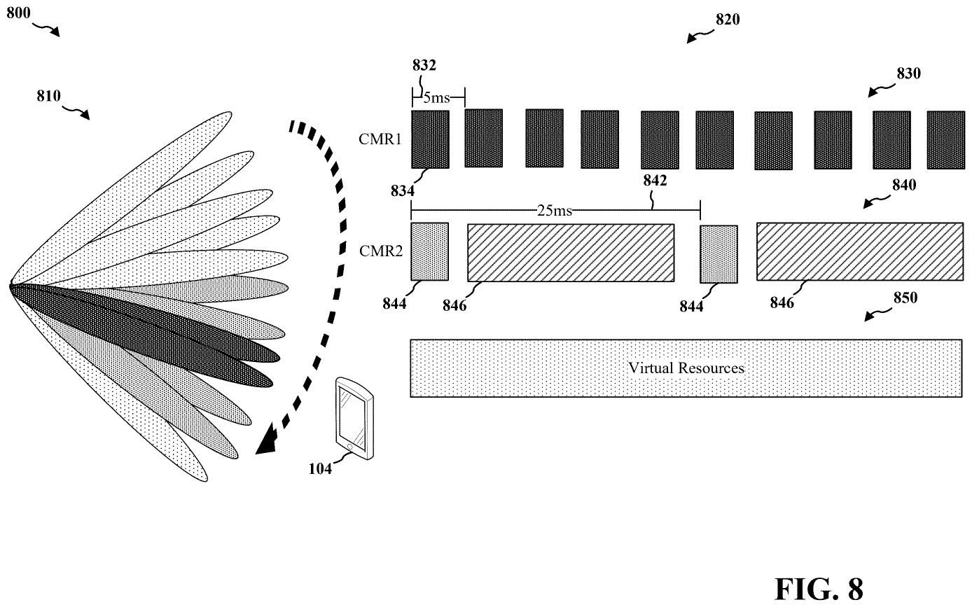

FIG. 8 is a diagram 800 of an association between various reference signal beam shapes 810 and measurement resources 820. The reference signal beam shapes 810 may be defined according to a codebook or by properties such as a beam pointing direction, AoD, AoA, angular-specific beamforming gain; or angular difference from a boresight direction for a specified beamwidth.

The measurement resources 820 may include one or more CMR sets 830, 840 and virtual resources 850. For example, a first CMR set 830 may be configured with a relatively short periodicity 832 (e.g., 5 ms) for CSI-RS resources 834 associated with a first subset of the reference signal beam shapes 810. In FIG. 8, the pattern of the reference signal beam shapes 810 matching the pattern of the resources 820 indicates the associated resources. The base station 102 may transmit a CSI-RS on the CSI-RS resources 834 of the first CMR set 830 according to the periodicity 832. The UE 104 may measure channel characteristics based on the CSI-RS received at the UE 104. Example channel characteristics may include CSI values such as L1-RSRP, L1-SINR, precoder matrix indicator (PMI), rank indicator (RI), channel quality indicator (CQI), or layer indicator (LI). In some implementations, the first CMR set 830 may be associated with one or more beams. In particular, the one or more beams associated with the CSI-RS resources of the first CMR set 830 with the shortest periodicity 832 may be dynamically selected to include the current beam and/or beams to which the UE is most likely to change.

The second CMR set 840 may be configured for the UE 104 with a relatively longer periodicity 842 (e.g., 25 ms or 40 ms) for CSI-RS resources 844 for a second subset of the reference signal beam shapes 810. The second subset of beams may be larger (e.g., 4 beams) compared to the first subset of beams (e.g., 2 beams). Accordingly, the base station 102 may transmit the CSI-RSs for the second CMR set 840 less frequently than the CSI-RSs for the first CMR set 830, and the UE 104 may obtain measurements of the corresponding subset of the reference signal beam shapes 810 less frequently. In some implementations, a CSI-RS may not be transmitted on the second CMR 840 during periods 846 between the CSI-RS resources 844. The periods 846 may be considered virtual resources because the UE 104 may generate predicted channel characteristics for the second CMR set 840 for the periods 846.

The virtual resources 850 may be associated with a third subset of the reference signal beam shapes 810. The virtual resources 850 may not include any actual CSI-RS resources. That is, the base station 102 may not transmit a CSI-RS on the virtual resources 850, and the UE 104 may not measure a CSI-RS on the virtual resources. Instead, the virtual resources 850 may be independent of any reference signal transmitted therein. For instance, the UE 104 may predict channel characteristics of the third subset of the reference signal beam shapes 810 associated with the virtual resources 850 based on beam shape information and the measured characteristics of the first CMR set 830 and/or the second CMR set 840 (e.g., using the techniques discussed above with respect to FIGS. 5-7).

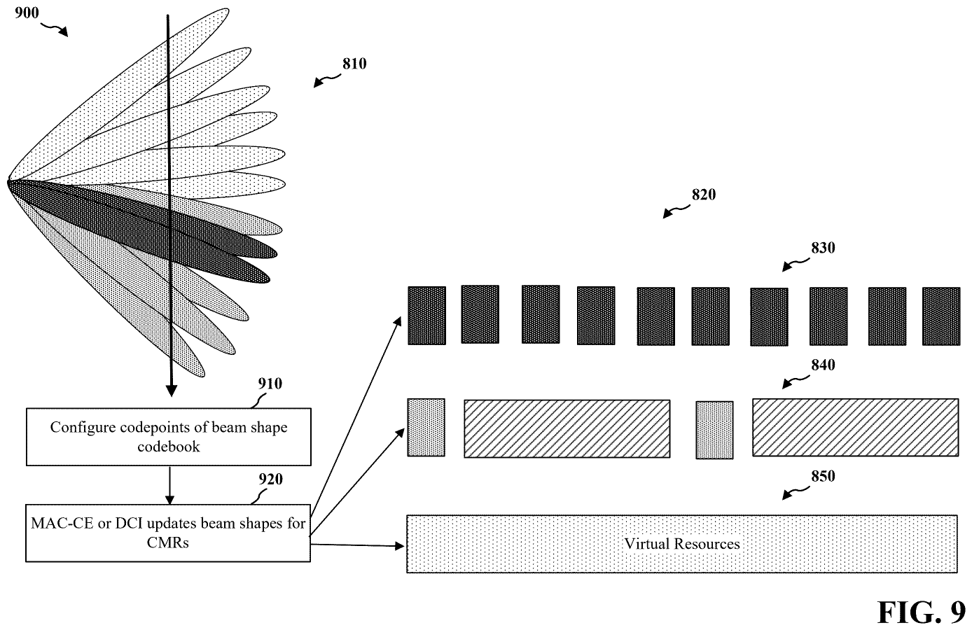

FIG. 9 is a diagram 900 of indicating a dynamic beam shape associated with the resources 820 using codepoints. A serving cell may configure beam shape codepoints independently or in association with a CSI report configuration. The beam shape codepoints may map each reference signal beam shape 810 (and associated CSI-RS) to an index that may be signaled in a dynamic indication such as a media access control (MAC) control element (CE) or downlink control information (DCI). For the illustrated example, the indices may be from 0 to 11.

For example, at block 910, the base station 102 may transmit an RRC configuration message indicating the codepoints of a beam shape codebook. The base station 102 may configure the resources 820 for CSI reporting in the same RRC configuration message, or via separate CSI report configuration. At block 920, the base station 102 may transmit a MAC-CE or DCI that updates beam shapes for the resources 820. For instance the MAC-CE or DCI may identify the codepoints associated with each CMR. As illustrated, the MAC-CE or DCI may indicate codepoints 3 and 4 for the first CMR 830 and codepoints 0-2 and 5 for the second CMR 840. Remaining codepoints may be assigned to the virtual resources 850 or included in the MAC-CE or DCI. In some implementations, the MAC-CE may include updated beam shape information (e.g., a codepoint) for each resource 820. In some implementations, a MAC-CE may include pairs of resource identifiers and codepoints. For a DCI, a more compact indication may identify a codepoint applicable to all resources associated with the DCI. For instance, the serving cell may preconfigure the UE for a CSI report setting associated with a codebook including all beam shapes with which the CMR sets 830, 840 or the virtual resources 850 can be associated. The DCI (or a MAC-CE) may indicate a codepoint within the codebook regarding the applicable resources as an update to the beam shapes regarding the resources. Accordingly, the base station may dynamically update the beam shape information such that the UE 104 measures a prioritized set of beams more frequently and uses predicted channel characteristics for other beams.

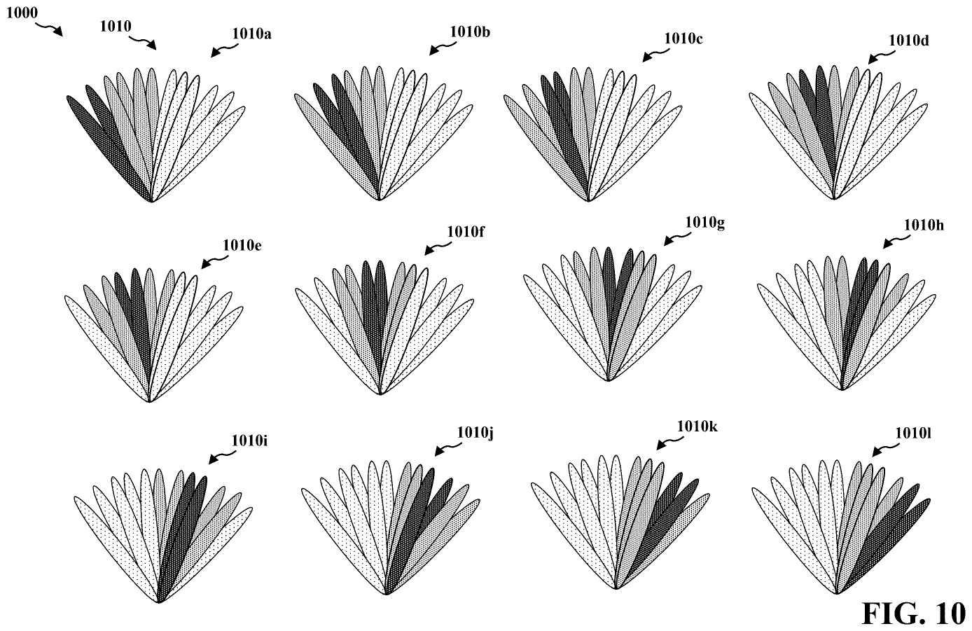

FIG. 10 is a diagram of a configuration 1000 for a compact indication of beam information. The configuration 1000 may define a plurality of beam shape sets 1010. Each beam shape set 1010 (e.g., beam shape sets 1010a-1010l) may identify a resource 820 associated with each beam. For example, the beam shape set 1010 may be preconfigured by a serving cell for a CSI report or in settings associated with a CSI report. For example, the CSI report may be linked with the two CMR sets 830, 840 and the virtual resources 850. In some implementations, each beam shape set 1010 may include a number of resources corresponding to the resources configured for the CSI report (e.g., 2 CSI-RS resources for CMR set 830, 4 CSI-RS resources for CMR set 840, and 6 virtual resources 850). A DCI or MAC-CE may identify an index of a beam shape set 1010 to indicate the beam shape information associated with each resource.

In some implementations, a UE 104 may dynamically recommend a beam shape, for example, based on non-codebook prediction as discussed with respect to FIG. 6. For instance, the UE 104 may report a beam shape set 1010 (e.g., in uplink control information (UCI) or uplink MAC-CE) that associates a beam that is closest to a best beam 632 with the first CMR set 830. That is, the UE 104 may report a codepoint or index corresponding to a beam shape set 1010, and the base station may accept the UE suggestion by sending a MAC-CE or DCI with the same beam shape set 1010.

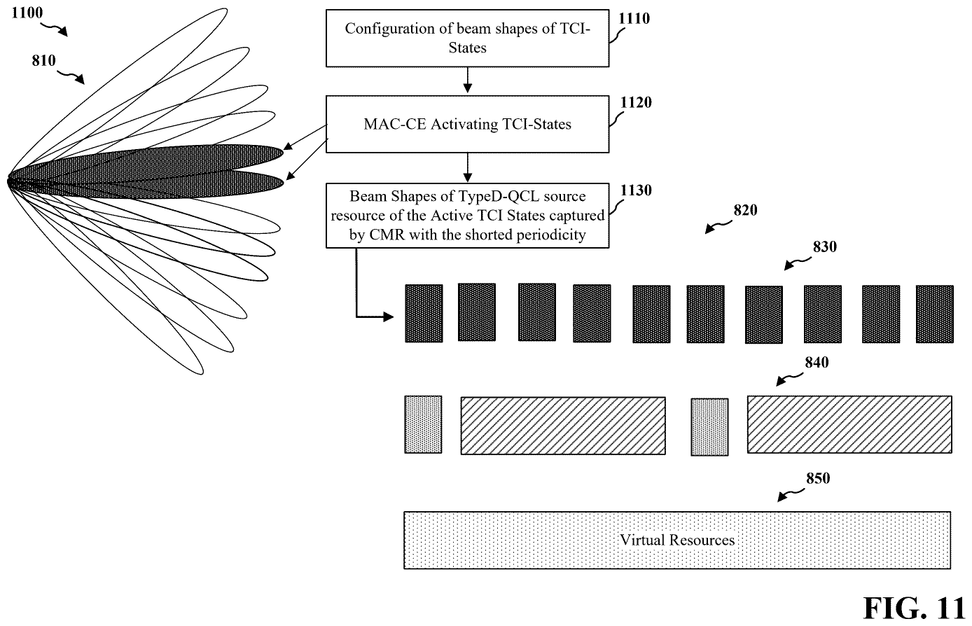

FIG. 11 is a diagram 1100 of associating beam shape information for a set of reference signal beam shapes 810 with resources 820 based on active transmission configuration indication (TCI) states. A TCI state may be configured with transmission parameters for a downlink transmission. For instance, the TCI state may specify a beam. Accordingly, a beam shape for a CSI-RS may be TypeD quasi-co-located (QCL) with a source for downlink transmission. For example, at block 1110, the base station 102 may configure beam shapes of TCI-states. For instance, the base station may transmit a configuration of the TCI states that includes beam information. At block 1120, the base station 102 may transmit a MAC-CE that activates one or more TCI states. That is, the MAC-CE may down select the active TCI states from the configured TCI states. At block 1130, the UE 104 may associate beam shape information corresponding to the active TCI states with the CMR set 830 having the shortest periodicity 832.

In an aspect, the beams associated with an active TCI state may be important for channel measurements. The UE and the base station may implicitly agree or independently determine that the beams associated with an active TCI state are captured by the CMR set 830 with the shortest periodicity 832. The beam shapes of such resources could be separately identified by the UE. For example, the serving cell may preconfigure beamformable shapes and associated each resource/TCI-state with a beamformable shape in an RRC configuration. Alternatively, the MAC-CE activating the TCI-state may identify one of the beamformable shapes for a certain activated TCI-state. In some implementations, such beam shapes can be applied to the resources associated with the CSI report following an activation period (e.g., 3 ms) after the UE sends an ACK back to the base station regarding the MAC-CE. In some implementations, the beam shapes of the activated TCI states may be applied in order to the configured resources in the CMR set 830. If the number of beam shapes in the active TCI-state is greater than the number of resources in the CMR set 830, remaining beam shapes in the TCI-states are not mapped to the resources in the CMR set 830. If the number of beam shapes in the active TCI-state is less than the number of resources in the CMR set 830, the beam shapes of the remaining resources in the CMR set 830 may be indicated based on on other dynamic indications (e.g., codepoints or beam choices).

In some implementations, the UE 104 may expect that the resources in the CMR set 830 with the shortest periodicity would be TypeD-QCL with the resources being TypeD-QCL sources of MAC-CE activated TCI-states, or being such TypeD-QCL sources themselves. The beam shapes of the resources may be separately identified. For example, the considered resource set may always include the same number of resources that can be TypeD-QCL sources of MAC-CE activated TCI-states, and the MAC-CE activating TCI-states may implicitly update the resources included in the considered resource set.

In an aspect, the UE 104 may report CSI by transmitting one or more CSI reports. Each CSI report may include at least one of: a) measured channel characteristics associated with one of more CMR sets 830, 840 that the UE measured (e.g., on CSI-RS resources 834, 844); b) predicted channel characteristics associated with one or more CMR sets 830, 840 that the UE predicted (e.g., for period 846 when the CSI-RS is not transmitted); or c) predicted channel characteristics associated with one or more sets of virtual resources 850.

For example, a single CSI report may include channel characteristics for both the CMR sets 830, 840, and the virtual resources 850. For instance, dynamic beam information may be associated with a configuration of the single CSI report. In some implementations, a MAC-CE or DCI indicating the beam shape information may include an identifier of the CSI report setting associated with the CSI report. The UE 104 may associate the beam shape information with the identified CSI report. In some implementations, a MAC-CE for activating semi-persistent CSI reports may be extended to include the beam shape information. In some implementations, a mechanism for aperiodic CSI triggering state configuration can be extended to include the beam shape information. Alternatively, a new MAC-CE or DCI format may be defined to carry the beam shape information

In another example, the UE 104 may transmit multiple CSI reports. For instance, each CSI report may correspond to a set of resources 820 (e.g., CMR set 830, CMR set 840, or virtual resources 850). The multiple CSI reports may be linked together. For example, a leading CSI report may be linked with additional CSI reports via a CSI report setting, a MAC-CE that activates a semi-persistent CSI report, or a DCI that triggers an aperiodic CSI report. A dynamic indication of beam shape information may be separately associated with each CSI report. For instance, referring back to FIG. 9, one or more codepoints may be indicated for each CSI report. In some implementations, a single MAC-CE or DCI may indicate the beam shape information for the multiple CSI reports. For instance, a group of linked CSI reports may be associated with a group identifier, which may be indicated in the MAC-CE or DCI. The UE 104 may associate the beam shape information indicated by the MAC-CE or DCI with each CSI report associated with the group identifier. In some implementations, a separate MAC-CE or DCI may provide the beam shape information for each CSI report. The UE 104 may associate the beam shape information with the corresponding CSI report.

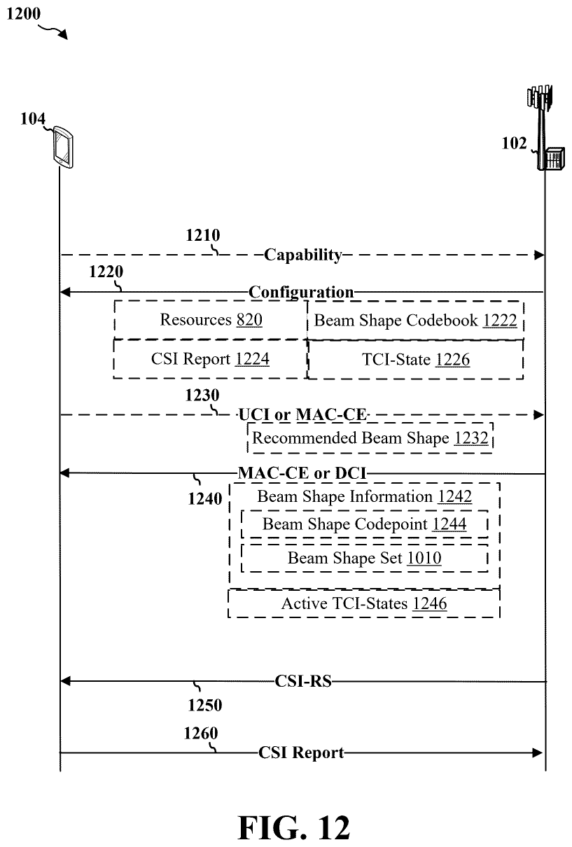

FIG. 12 is a message diagram 1200 illustrating example messages between a base station 102 and a UE 104. The UE 104 may be an example of a UE 104 including the beam management component 140. The base station 102 may include the prediction control component 120.

In some implementations, the UE 104 may optionally transmit a capability message 1210 to the base station 102. For example, the capability message 1210 may be a RRC message. The capability message 1210 may indicate, for example, that the UE 104 is capable of predicting channel characteristics based on beam shape information.

The base station 102 may transmit a configuration 1220. The configuration 1220 may be, for example, an RRC message. For example, the configuration 1220 may include a configuration of resources 820. For instance, the configuration 1220 may identify the CMR sets 830,840 and corresponding periodicities 832, 842. In some implementations, the configuration 1220 may include a beam shape codebook 1222. The beam shape codebook 1222 may associate a codepoint with various beams, which may be associated with a respective CSI-RS. The configuration 1220 may include a configuration of a CSI report 1224. For example, the configuration of the CSI report 1224 may identify values of the resources 820 to include in one or more CSI reports 1260. In some implementations, the configuration 1220 may include a configuration of TCI-states 1226.

The UE 104 may optionally transmit a UCI or MAC-CE 1230 including a recommended beam shape 1232. For instance, the recommended beam shape 1232 may identify a beam shape codepoint from the beam shape codebook 1222 or a beam shape set 1010.

The base station 102 may transmit a MAC-CE or DCI 1240 indicating beam shape information 1242. The beam shape information 1242 may include a beam shape codepoint 1244 from the beam shape codebook 1222 or a beam shape set 1010. The UE 104 may associate the beam shape information 1242 with the resources 820. In some implementations, the MAC-CE or DCI 1240 may optionally indicate active TCI-states 1246. The UE 104 may implicitly identify beam shape information to be associated with a first CMR set 830 based on the active TCI-states 1246.

The base station 102 may transmit CSI-RS 1350 on the CSI-RS resources 834, 844 of the CMR sets 830, 840. The UE 104 may measure the CSI-RS 1350 to determine channel characteristics associated with the CMR sets 830, 840. The UE 104 may also generate predicted channel characteristics associated with at least one of the virtual resources 850 based on the beam shape information 1242 and the measured channel characteristics.

The UE 104 may transmit one or more CSI reports including the channel characteristics associated with the CMR sets 830, 840 and the predicted channel characteristics associated with the virtual resources 850. In some implementations, the CSI report 1260 may be a single CSI report including both measured channel characteristics and predicted channel characteristics. In some implementations, the CSI report 1260 may include multiple CSI reports, for example, with each CSI report being associated with a set of the resources 820.

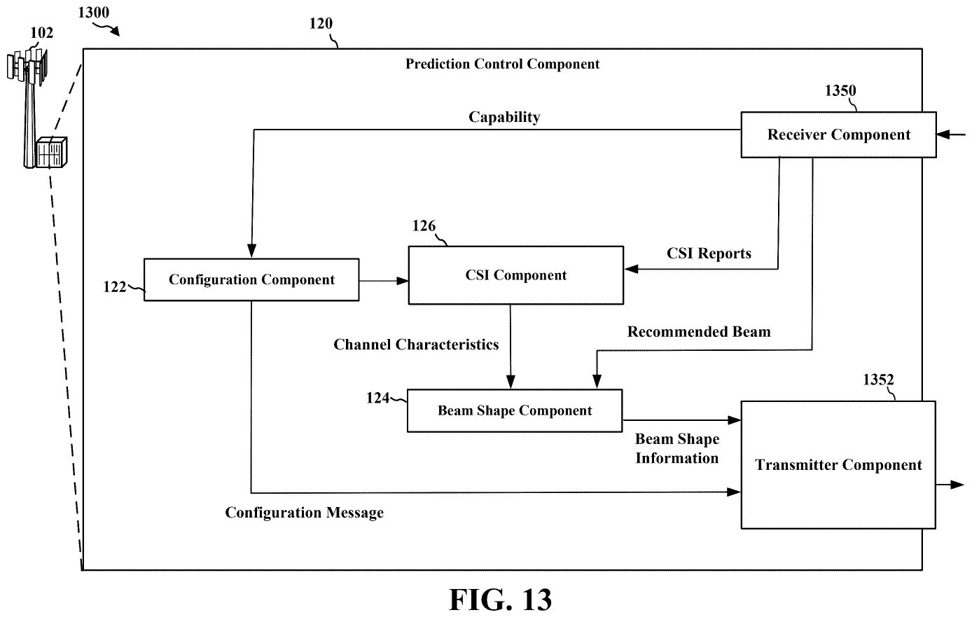

FIG. 13 is a conceptual data flow diagram 1300 illustrating the data flow between different means/components in an example base station 102, which may be an example of the base station 102 including the prediction control component 120. The prediction control component 120 may be implemented by the memory 376 and the Tx processor 316, the Rx processor 370, and/or the controller/processor 375 of FIG. 3. For example, the memory 376 may store executable instructions defining the prediction control component 120 and the Tx processor 316, the Rx processor 370, and/or the controller/processor 375 may execute the instructions.

The base station 102 may include a receiver component 1350, which may include, for example, a radio frequency (RF) receiver for receiving the signals described herein. The base station 102 may include a transmitter component 1352, which may include, for example, an RF transmitter for transmitting the signals described herein. In an aspect, the receiver component 1350 and the transmitter component 1352 may co-located in a transceiver such as illustrated by the Tx/Rx 318 in FIG. 3.

As discussed with respect to FIG. 1, the prediction control component 120 may include the configuration component 122, the beam shape component 124, and the CSI component 126.

The receiver component 1350 may receive UL signals from the UE 104 including the capability message 1210, the UCI or MAC-CE 1230, or the CSI report 1260. The receiver component 1350 may provide the capability message 1210 to the configuration component 122. The receiver component 1350 may provide the UCI or MAC-CE 1230 to the beam shape component 124. The receiver component 1350 may provide the CSI reports 1260 to the CSI component 126.

The configuration component 122 may be configured to configure a UE with one or more CMR sets 830, 840 and virtual resources 850. For example, the configuration component 122 may generate an RRC configuration 1220 including the resources 820. In some implementations, the configuration component 122 may include the virtual resources 850 in response to the capability message 1210 indicating that the UE 104 can predict channel characteristics. The configuration component 122 may output the configuration 1220 for transmission via the transmitter component 1352.

The beam shape component 124 may be configured to indicate beam shape information for the one or more CMR sets and the virtual resources. For example, the beam shape component 124 may obtain a recommended beam shape 1232 via the receiver component 1250. The beam shape component 124 may also obtain channel characteristics from the CSI component 126. The beam shape component 124 may select beam shape information to be associated with the configured CMR sets 830, 840 based on the recommended beam shape 1232 and/or the channel characteristics. For example, the beam shape component 124 may select beams of the most interest (e.g., a current beam or beam change candidate) for association with the first CMR set 830 having the shortest periodicity 832. In some implementations, the beam shape component 124 may implicitly indicate the beam shape information by activating a TCI-state associated with beam information. In other implementations, the beam shape component 124 may output the indication as a selected codepoint or a selected beam shape set 1010. The beam shape component 124 may output the beam shape information 1242 for transmission via the transmitter component 1352, for example, as a MAC-CE or DCI.

The CSI component 126 may be configured to obtain CSI that includes measured channel characteristics associated with the one or more CMR sets and predicted channel characteristics associated with the virtual resources. For example, the CSI component 126 may obtain one or more CSI reports via the receiver component 1250. The CSI component 126 may obtain a configuration of the CSI reports from the configuration component 122. The CSI component 126 may extract the channel characteristics from the CSI reports. In some implementations, the CSI component 126 may output the channel characteristics to the beam shape component 124 for selecting a beam shape. In some implementations, the CSI component 126 may perform other beam management operations based on the channel characteristics, or output the channel characteristics to a respective beam management component. The other beam management operations may include, for example, initial access, secondary cell group setup, serving beam refinement, link quality and interference adaptation, beam failure or blockage prediction, or radio link failure prediction.

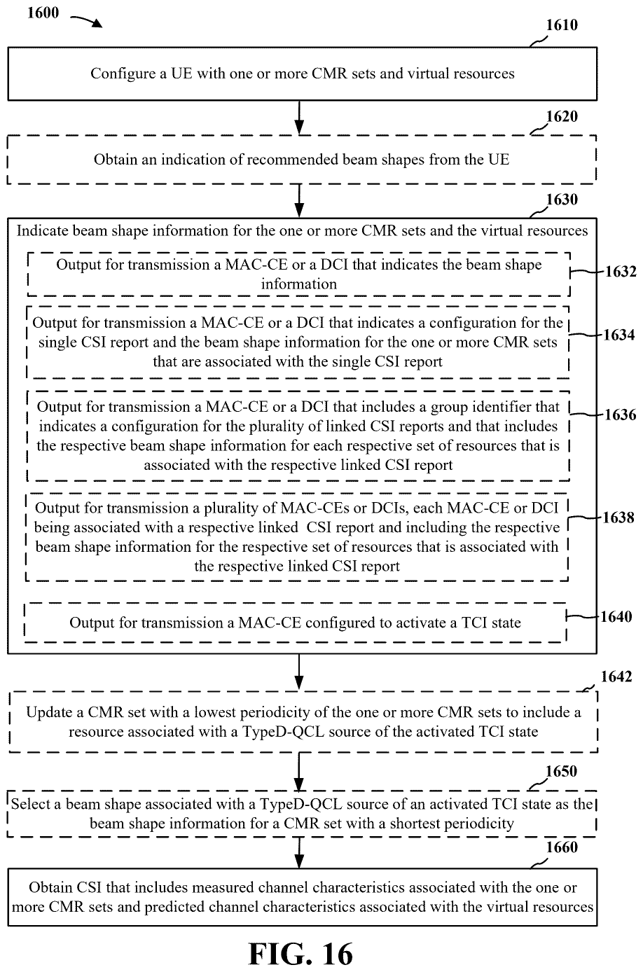

Various components of base station 102 may provide means for performing the methods described herein, including with respect to FIG. 16. In some examples, means for transmitting, outputting, or sending (or means for outputting for transmission) may include the transceivers 318TX and/or antenna(s) 320 of the base station 102 illustrated in FIG. 3 and/or the transmitter component 1352 of the base station 102 in FIG. 13. Means for configuring, indicating, obtaining, selecting, and updating may include the controller/processor 375, memory 376, and other various processors of FIG. 3 and/or the various components of FIG. 13 discussed above.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 13 is an example, and many other examples and configurations of the base station 102 are possible.

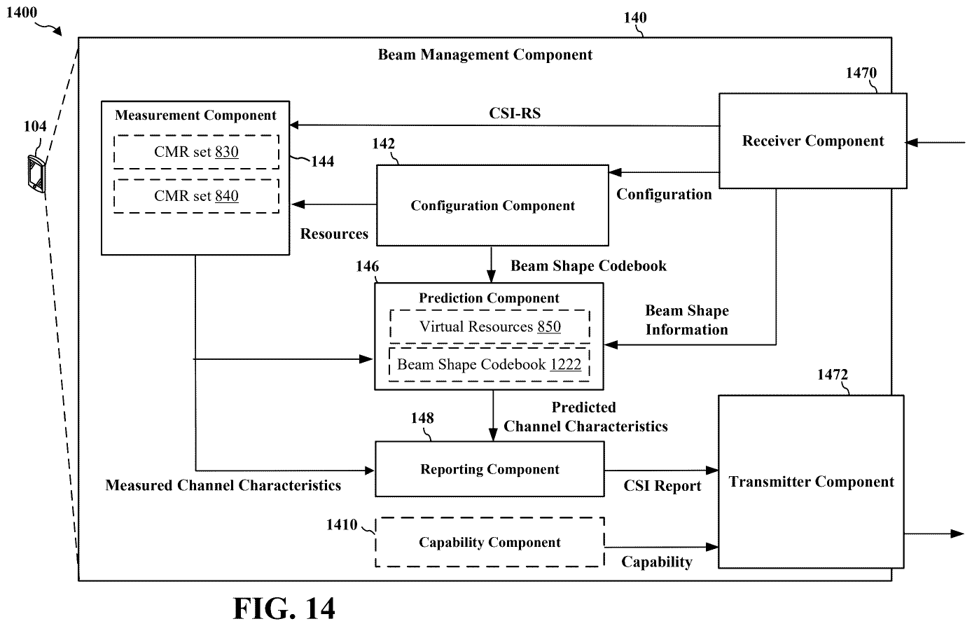

FIG. 14 is a conceptual data flow diagram 1400 illustrating the data flow between different means/components in an example UE 104, which may include the beam management component 140. The beam management component 140 may be implemented by the memory 360 and the Tx processor 368, the Rx processor 356, and/or the controller/processor 359. For example, the memory 360 may store executable instructions defining the Beam management component 140 and the Tx processor 368, the Rx processor 356, and/or the controller/processor 359 may execute the instructions.

The UE 104 may include a receiver component 1470, which may include, for example, a RF receiver for receiving the signals described herein. The UE 104 may include a transmitter component 1472, which may include, for example, an RF transmitter for transmitting the signals described herein. In an aspect, the receiver component 1470 and the transmitter component 1472 may co-located in a transceiver such as the Tx/Rx 352 in FIG. 3.

As discussed with respect to FIG. 1, the beam management component 140 may include the configuration component 142, the measurement component 144, the prediction component 146, and the reporting component 148. In some implementations, the beam management component 140 may optionally include a capability component 1410.

The receiver component 1470 may receive DL signals described herein such as the configuration 1220, the MAC-CE or DCI 1240, and the CSI-RS 1250. The receiver component 1470 may provide the configuration 1220 to the configuration component 142. The receiver component 1470 may provide MAC-CE or DCI 1240 to the prediction component 146. The receiver component 1470 may provide the CSI-RS 1250 to the measurement component 144.

In some implementations, the capability component 1410 may be configured to output for transmission an indication of a capability of the UE to generate predicted channel characteristics. For example, the capability component 1410 may output an RRC capability message 1210 via the transmitter component 1472.

In some implementations, the configuration component 142 may be configured to obtain a configuration of resources 820 including one or more CMR sets 830, 840 and virtual resources 850. For example, the configuration component 142 may receive the configuration 1220, which may be an RRC configuration message, for example. The configuration component 142 may configure the measurement component 144 with the one or more CMR sets 830, 840 and associated periodicities 832, 842. In some implementations, the configuration 1220 (or another configuration message) may include a configuration of a beam shape codebook 1222. The configuration component 142 may configure the measurement component 144 and/or the prediction component 146 with the beam shape codebook 1222. In some implementations, the configuration 1220 (or another configuration message) may include a configuration of CSI reports 1224. The configuration component 142 may configure the reporting component 148 with the configuration of CSI reports 1224. In some implementations, the configuration 1220 (or another configuration message) may include a configuration of TCI-states 1226. The configuration component 142 may configure the receiver component 1470 and/or the measurement component 144 with the TCI-states 1226.

The measurement component 144 may be configured to measure channel characteristics associated with the one or more CMR sets based on beam shape information and one or more of the unique measurement periodicities. For example, the measurement component 144 may measure an RSRP or SINR of the CSI-RS 1250, which may be obtained according to the periodicity 832, 842 of the CMR sets 830, 840. The measurement component 144 may output the measured channel characteristics to the prediction component 146 and/or the reporting component 148.

The prediction component 146 may be configured to generate predicted channel characteristics associated with at least one of the virtual resources 850 based on the beam shape information and the channel characteristics. For example, the prediction component 146 may obtain the beam shape information via the receiver component 1470. In some implementations, the prediction component 146 may use the beam shape codebook 1222 to determine the beam shape information from an indication in the MAC-CE or DCI 1240. The prediction component 146 may obtain the measured channel characteristics from the measurement component 144. In some implementations, the prediction component 146 may use machine-learning or artificial intelligence based prediction for codebook selection and/or non-codebook based prediction as discussed above regarding FIGS. 5-7. For example, the prediction component 146 may include the model 520 and/or the model 620. The prediction component 146 may store the time series 710 based on the measured channel characteristics. The prediction component 146 may output the predicted channel characteristics to the reporting component 148.

The reporting component 148 may be configured to report CSI comprising the channel characteristics and the predicted channel characteristics. For example, the reporting component 148 may obtain the measured channel characteristics from the measurement component 144 and obtain the predicted channel characteristics from the prediction component 146. The reporting component may generate a CSI report based on the configuration of the CSI report 1224. The reporting component 148 may output one or more CSI reports for transmission via the transmitter component 1472.

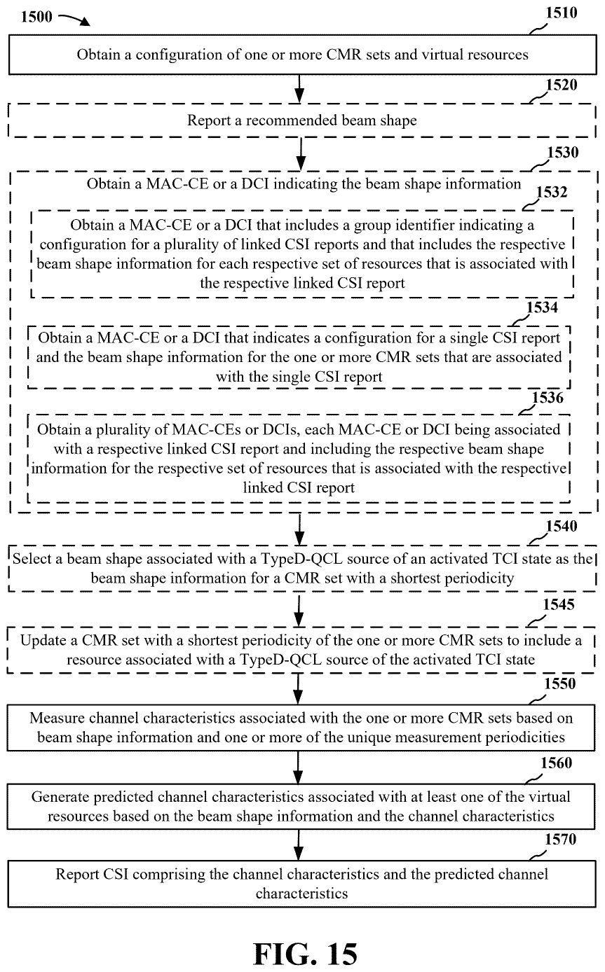

Various components of base station 102 may provide means for performing the methods described herein, including with respect to FIG. 15. In some examples, means for transmitting, outputting, or sending (or means for outputting for transmission) may include the transceivers 354TX and/or antenna(s) 352 of the UE 104 illustrated in FIG. 3 and/or the transmitter component 1472 of the UE 104 in FIG. 14. Means for measuring, generating, reporting, obtaining, selecting, and updating may include the controller/processor 359, memory 360, and other various processors of FIG. 3 and/or the various components of FIG. 14 discussed above.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 14 is an example, and many other examples and configurations of the UE 104 are possible.

FIG. 15 is a flowchart of an example method 1500 for a UE 104 to report CSI including measured channel characteristics and predicted channel characteristics. The method 1500 may be performed by a UE 104 (such as the UE 104, which may include the memory 360 and which may be the entire UE 104 or a component of the UE 104 such as the beam management component 140, Tx processor 368, the Rx processor 356, or the controller/processor 359). The method 1500 may be performed by the beam management component 140 in communication with the prediction control component 120 of the base station 102. Optional blocks are shown with dashed lines.

At block 1510, the method 1500 includes obtaining a configuration of one or more CMR sets and virtual resources. In some implementations, for example, the UE 104, the Rx processor 356 or the controller/processor 359 may execute the beam management component 140 or the configuration component 142 to obtain a configuration 1220 of one or more CMR sets 830, 840 and virtual resources 850. Accordingly, the UE 104, the Rx processor 356, or the controller/processor 359 executing the beam management component 140 or the configuration component 142 may provide means for obtaining a configuration of one or more CMR sets and virtual resources.

At block 1520, the method 1500 may optionally include report a recommended beam shape. In some implementations, for example, the UE 104, the Tx processor 368 or the controller/processor 359 may execute the beam management component 140 or the prediction component 146 to report a recommended beam shape. For instance, the prediction component 146 may output a MAC-CE or DCI 1230 for transmission via the transmitter component 1472. Accordingly, the UE 104, the Tx processor 368, or the controller/processor 359 executing the beam management component 140 or the prediction component 146 may provide means for reporting a recommended beam shape.

At block 1530, the method 1500 may optionally include obtaining a MAC-CE or a DCI indicating the beam shape information. In some implementations, for example, the UE 104, the Rx processor 356 or the controller/processor 359 may execute the beam management component 140 or the prediction component 146 to obtain a MAC-CE or a DCI 1240 indicating the beam shape information. In some implementations, the beam shape information includes at least one of: a beam pointing direction for a CMR or a virtual resource; an angular-specific beamforming gain; or an angular difference from a boresight direction for a specified beamwidth. In some implementations, the MAC-CE or a DCI 1240 is configured to activate a TCI state. In some implementations, for example, at sub-block 1532, the block 1530 may optionally include obtaining a MAC-CE or a DCI that includes a group identifier indicating a configuration for a plurality of linked CSI reports and that includes the respective beam shape information for each respective set of resources that is associated with the respective linked CSI report. In some implementations, the MAC-CE or the DCI includes a codepoint indication of a configured codebook of beam shapes to be associated with the one or more CMR sets and the virtual resources. In some implementations, the MAC-CE or the DCI identifies a beam shape set associated with a CSI report, where the beam shape set associates the beam shape information with the one or more CMR sets and the virtual resources. As another example, at sub-block 1534, the block 1530 may optionally include obtaining a MAC-CE or a DCI that indicates a configuration for a single CSI report and the beam shape information for the one or more CMR sets that are associated with the single CSI report. As another example, at sub-block 1536, the block 1530 may optionally include obtaining a plurality of MAC-CEs or DCIs, each MAC-CE or DCI being associated with a respective linked CSI report and including the respective beam shape information for the respective set of resources that is associated with the respective linked CSI report. Accordingly, the UE 104, the Rx processor 356, or the controller/processor 359 executing the beam management component 140 or the prediction component 146 may provide means for obtaining a MAC-CE or a DCI indicating the beam shape information.

At block 1540, the method 1500 may optionally include selecting a beam shape associated with a TypeD-QCL source of an activated TCI state as the beam shape information for a CMR set with a lowest periodicity. In some implementations, for example, the UE 104, the Rx processor 356 or the controller/processor 359 may execute the beam management component 140 or the prediction component 146 to select a beam shape associated with a TypeD-QCL source of an activated TCI state as the beam shape information for a CMR set 830 with a shortest periodicity 832. Accordingly, the UE 104, the Rx processor 356, or the controller/processor 359 executing the beam management component 140 or the prediction component 146 may provide means for selecting a beam shape associated with a TypeD-QCL source of an activated TCI state as the beam shape information for a CMR set with a lowest periodicity.

At block 1545, the method 1500 may optionally include updating a CMR set with a shortest periodicity of the one or more CMR sets to include a resource associated with a TypeD-QCL source of the activated TCI state. In some implementations, for example, the UE 104, the Rx processor 356 or the controller/processor 359 may execute the beam management component 140 or configuration component 142 to update a CMR set with a shortest periodicity of the one or more CMR sets to include a resource associated with a TypeD-QCL source of the activated TCI state. Accordingly, the UE 104, the Rx processor 356, or the controller/processor 359 executing the beam management component 140 or the configuration component 142 may provide means for updating a CMR set with a shortest periodicity of the one or more CMR sets to include a resource associated with a TypeD-QCL source of the activated TCI state.

At block 1550, the method 1500 includes measuring channel characteristics associated with the one or more CMR sets based on beam shape information and one or more of the unique measurement periodicities. In some implementations, for example, the UE 104, the Rx processor 356. or the controller/processor 359 may execute the beam management component 140 or the measurement component 144 to measure channel characteristics associated with the one or more CMR sets 830, 840 based on beam shape information and one or more of the unique measurement periodicities 832, 842. Accordingly, the UE 104, the Rx processor 356, or the controller/processor 359 executing the beam management component 140 or the measurement component 144 may provide means for measuring channel characteristics associated with the one or more CMR sets based on beam shape information and one or more of the unique measurement periodicities.

At block 1560, the method 1500 includes generating predicted channel characteristics associated with at least one of the virtual resources based on the beam shape information and the channel characteristics. In some implementations, for example, the UE 104, the Rx processor 356. or the controller/processor 359 may execute the beam management component 140 or the prediction component 146 to generate predicted channel characteristics associated with at least one of the virtual resources 850 based on the beam shape information and the channel characteristics. Accordingly, the UE 104, the Rx processor 356, or the controller/processor 359 executing the beam management component 140 or the prediction component 146 may provide means for generating predicted channel characteristics associated with at least one of the virtual resources based on the beam shape information and the channel characteristics.

At block 1570, the method 1500 includes reporting CSI comprising the channel characteristics and the predicted channel characteristics. In some implementations, for example, the UE 104, the Tx processor 368 or the controller/processor 359 may execute the beam management component 140 or the reporting component 148 to report CSI comprising the channel characteristics and the predicted channel characteristics. In some implementations, reporting the CSI includes outputting for transmission at least one CSI report. A CSI report may include one or more of the channel characteristics associated with the one or more CMR sets corresponding to time domain occasions at which beams are received on the one or more CMR sets; predicted channel characteristics associated with the one or more CMR sets corresponding to time domain occasions at which beams are not received on the one or more CMR sets; or the predicted channel characteristics associated with the virtual resources on which no beam is received. In some implementations (e.g., when the method 1500 includes sub-block 1534), the at least one CSI report is a single CSI report associated with the beam shape information. In some implementations (e.g., when the method 1500 includes sub-block 1532 or 1536), the at least one CSI report includes a plurality of linked CSI reports, each linked CSI report being associated with a respective set of resources and a respective beam shape information. Accordingly, the UE 104, the Tx processor 368, or the controller/processor 359 executing the beam management component 140 or the reporting component 148 may provide means for reporting CSI comprising the channel characteristics and the predicted channel characteristics.

FIG. 16 is a flowchart of an example method 1600 for a base station to control UE CSI reporting based on predicted channel characteristics. The method 1600 may be performed by a base station (such as the base station 102, which may include the memory 376 and which may be the entire base station 102 or a component of the base station 102 such as the prediction control component 120, the Tx processor 316, the Rx processor 370, or the controller/processor 375). The method 1600 may be performed by the prediction control component 120 in communication with the beam management component 140 of the UE 104.

At block 1610, the method 1600 includes configuring a UE with one or more CMR sets and virtual resources. In some implementations, for example, the base station 102, the Tx processor 316, or the controller/processor 375 may execute the prediction control component 120 or the configuration component 122 to configure the UE 104 with one or more CMR sets 830, 840 and virtual resources 850. Accordingly, the base station 102, the Tx processor 316, or the controller/processor 375 executing the prediction control component 120 or the configuration component 122 may provide means for configuring a UE with one or more CMR sets and virtual resources.

At block 1620, the method 1600 may optionally include obtaining an indication of recommended beam shapes from the UE. In some implementations, for example, the base station 102, the Rx processor 370, or the controller/processor 375 may execute the prediction control component 120 or the beam shape component 124 to obtain an indication of recommended beam shapes 1232 from the UE. Accordingly, the base station 102, the Rx processor 370, or the controller/processor 375 executing the prediction control component 120 or the beam shape component 124 may provide means for obtaining an indication of recommended beam shapes from the UE.

At block 1630, the method 1600 includes indicating beam shape information for the one or more CMR sets and the virtual resources. In some implementations, for example, the base station 102, the Tx processor 316, or the controller/processor 375 may execute the prediction control component 120 or the beam shape component 124 to indicate beam shape information for the one or more CMR sets and the virtual resources. In some implementation, the beam shape information includes at least one of: a beam pointing direction for a CMR or a virtual resource; an angular-specific beamforming gain; or an angular difference from a boresight direction for a specified beamwidth. In some implementations, the MAC-CE or the DCI includes a codepoint indication of a configured codebook of beam shapes to be associated with the one or more CMR sets and the virtual resources. In some implementations, the MAC-CE or the DCI identifies a beam shape set associated with a CSI report, wherein the beam shape set associates the beam information with the one or more CMR sets and the virtual resources.

In some implementations, for example, at sub-block 1632, the block 1630 may optionally include outputting for transmission a MAC-CE or a DCI 1240 that indicates the beam shape information 1242. As another example, at sub-block 1634, the block 1630 may optionally include outputting for transmission a MAC-CE or a DCI that indicates a configuration for the single CSI report and the beam shape information for the one or more CMR sets that are associated with the single CSI report. As another example, at sub-block 1636, the block 1630 may optionally include outputting for transmission a MAC-CE or a DCI that includes a group identifier that indicates a configuration for the plurality of linked CSI reports and that includes the respective beam shape information for each respective set of resources that is associated with the respective linked CSI report. As another example, at sub-block 1638, the block 1630 may optionally include outputting for transmission a plurality of MAC-CEs or DCIs, each MAC-CE or DCI being associated with a respective linked CSI report and including the respective beam shape information for the respective set of resources that is associated with the respective linked CSI report. As another example, at sub-block 1640, the block 1630 may optionally include outputting for transmission a MAC-CE configured to activate a TCI state. In view of the foregoing, the base station 102, the Tx processor 316, or the controller/processor 375 executing the prediction control component 120 or the beam shape component 124 may provide means for indicating beam shape information for the one or more CMR sets and the virtual resources.

At block 1642, the method 1600 may optionally include updating a CMR set with a shortest periodicity of the one or more CMR sets to include a resource associated with a TypeD-QCL source of the activated TCI state. In some implementations, for example, the base station 102, the Tx processor 316, or the controller/processor 375 may execute the prediction control component 120 or the configuration component 122 to update a CMR set with a shortest periodicity of the one or more CMR sets to include a resource associated with a TypeD-QCL source of the activated TCI state. Accordingly, the base station 102, the Tx processor 316, or the controller/processor 375 executing the prediction control component 120 or the configuration component 122 may provide means for updating a CMR set with a shortest periodicity of the one or more CMR sets to include a resource associated with a TypeD-QCL source of the activated TCI state.

At block 1650, the method 1600 may optionally include selecting a beam shape associated with a TypeD-QCL source of an activated TCI state as the beam shape information for a CMR set with a shortest periodicity. In some implementations, for example, the base station 102, the Tx processor 316, or the controller/processor 375 may execute the prediction control component 120 or the beam shape component 124 to select a beam shape associated with a TypeD-QCL source of an activated TCI state as the beam shape information for a CMR set with a shortest periodicity. Accordingly, the base station 102, the Tx processor 316, or the controller/processor 375 executing the prediction control component 120 or the beam shape component 124 may provide means for selecting a beam shape associated with a TypeD-QCL source of an activated TCI state as the beam shape information for a CMR set with a shortest periodicity.

At block 1660, the method 1600 includes obtaining CSI that includes measured channel characteristics associated with the one or more CMR sets and predicted channel characteristics associated with the virtual resources. In some implementations, for example, the base station 102, the Rx processor 370, or the controller/processor 375 may execute the prediction control component 120 or the CSI component 126 to obtain CSI that includes measured channel characteristics associated with the one or more CMR sets and predicted channel characteristics associated with the virtual resources. For instance, the CSI component 126 may obtain the CSI report 1260 via the receiver component 1350. In some implementations (e.g., when the method 1600 includes sub-block 1634), the at least one CSI report is a single CSI report associated with the beam shape information. In some implementations (e.g., when the method 1600 includes sub-block 1636 or 1638), the at least one CSI report includes a plurality of linked CSI reports, each linked CSI report being associated with a respective set of resources and a respective beam shape information. Accordingly, the base station 102, the Rx processor 370, or the controller/processor 375 executing the prediction control component 120 or the CSI component 126 may provide means for obtaining CSI that includes measured channel characteristics associated with the one or more CMR sets and predicted channel characteristics associated with the virtual resources.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

### Example Aspects

Example 1 is a method of wireless communication at a user equipment (UE), comprising: obtaining a configuration of one or more channel measurement resource (CMR) sets and virtual resources, wherein each of the one or more CMR sets has a unique measurement periodicity and the virtual resources are independent of any transmission of a reference signal thereon; measuring channel characteristics associated with the one or more CMR sets based on beam shape information and one or more of the unique measurement periodicities; generating predicted channel characteristics associated with at least one of the virtual resources based on the beam shape information and the channel characteristics; and reporting channel state information (CSI) comprising the channel characteristics and the predicted channel characteristics.

Example 2 is the method of example 1, wherein the beam shape information includes at least one of: a beam pointing direction for a CMR or a virtual resource; an angular-specific beamforming gain; or an angular difference from a boresight direction for a specified beamwidth.

Example 3 is the method of example 1 or 2, further comprising obtaining a media access control (MAC) control element (CE) or a downlink control information (DCI) indicating the beam shape information.

Example 4 is the method of example 3, wherein the MAC-CE or the DCI includes a codepoint indication of a configured codebook of beam shapes to be associated with the one or more CMR sets and the virtual resources.

Example 5 is the method of example 3, wherein the MAC-CE or the DCI identifies a beam shape set associated with a CSI report, wherein the beam shape set associates the beam shape information with the one or more CMR sets and the virtual resources.

Example 6 is the method of example 3, further comprising reporting a recommended beam shape, wherein the MAC-CE or the DCI identifies the recommended beam shape previously reported by the UE.

Example 7 is the method of any of examples 1-6, wherein reporting CSI comprises outputting, for transmission, at least one CSI report including one or more of: the channel characteristics associated with the one or more CMR sets corresponding to time domain occasions at which beams are received on the one or more CMR sets; predicted channel characteristics associated with the one or more CMR sets corresponding to time domain occasions at which beams are not received on the one or more CMR sets; or the predicted channel characteristics associated with the virtual resources on which no beam is received.

Example 8 is the method of example 7, wherein the at least one CSI report is a single CSI report associated with the beam shape information.

Example 9 is the method of example 8, further comprising obtaining a MAC-CE or a DCI that indicates a configuration for the single CSI report and the beam shape information for the one or more CMR sets that are associated with the single CSI report.

Example 10 is the method of example 7, wherein the at least one CSI report includes a plurality of linked CSI reports, each linked CSI report being associated with a respective set of resources and a respective beam shape information.

Example 11 is the method of example 10, further comprising obtaining a MAC-CE or a DCI that includes a group identifier indicating a configuration for the plurality of linked CSI reports and that includes the respective beam shape information for each respective set of resources that is associated with the respective linked CSI report.

Example 12 is the method of example 10 or 11, further comprising obtaining a plurality of MAC-CEs or DCIs, each MAC-CE or DCI being associated with a respective linked CSI report and including the respective beam shape information for the respective set of resources that is associated with the respective linked CSI report.

Example 13 is the method of any of examples 1-12, further comprising selecting a beam shape associated with a TypeD-QCL source of an activated transmission configuration indicator (TCI) state as the beam shape information for a CMR set with a shortest periodicity of the one or more CMR sets.

Example 14 is the method of any of examples 1-12, further comprising: obtaining a MAC-CE activating a TCI state; and updating a CMR set with a shortest periodicity of the one or more CMR sets to include a resource associated with a TypeD-QCL source of the activated TCI state.

Example 15 is the method of wireless communication at a base station, comprising: configuring a user equipment (UE) with one or more channel measurement resource (CMR) sets and virtual resources, wherein each of the one or more CMR sets has a unique measurement periodicity and the virtual resources are independent of any transmission of a reference signal thereon; indicating beam shape information for the one or more CMR sets and the virtual resources; and obtaining channel state information (CSI) that includes measured channel characteristics associated with the one or more CMR sets and predicted channel characteristics associated with the virtual resources, wherein the predicted channel characteristics are based on the beam shape information and the measured channel characteristics.

Example 16 is the method of example 15, wherein the beam shape information includes at least one of: a beam pointing direction for a CMR or a virtual resource; an angular-specific beamforming gain; or an angular difference from a boresight direction for a specified beamwidth.

Example 17 is the method of example 15 or 16, wherein indicating the beam shape information comprises transmitting a media access control (MAC) control element (CE) or a downlink control information (DCI) that indicates the beam shape information.

Example 18 is the method of example 17, wherein the MAC-CE or the DCI includes a codepoint indication of a configured codebook of beam shapes to be associated with the one or more CMR sets and the virtual resources.

Example 19 is the method of example 17 or 18, wherein the MAC-CE or the DCI identifies a beam shape set associated with a CSI report, wherein the beam shape set associates the beam information with the one or more CMR sets and the virtual resources.

Example 20 is the method of any of examples 17-19, further comprising obtaining an indication of recommended beam shapes from the UE, wherein the MAC-CE or the DCI identifies the beam shape information from the recommended beam shapes.

Example 21 is the method of any of examples 15-20, wherein obtaining the CSI comprises obtaining at least one CSI report including one or more of: the measured channel characteristics associated with the one or more CMR sets corresponding to time domain occasions at which beams are transmitted on the one or more CMR sets; predicted channel characteristics associated with the one or more CMR sets corresponding to time domain occasions at which beams are not transmitted on the one or more CMR sets; or the predicted channel characteristics associated with the virtual resources on which no beam is transmitted.

Example 22 is the method of example 21, wherein the at least one CSI report is a single CSI report associated with the beam shape information.

Example 23 is the method of example 22, wherein indicating the beam shape information comprises outputting for transmission a MAC-CE or a DCI that indicates a configuration for the single CSI report and the beam shape information for the one or more CMR sets that are associated with the single CSI report.

Example 24 is the method of example 21, wherein the at least one CSI report includes a plurality of linked CSI reports, each linked CSI report being associated with a respective set of resources and a respective beam shape information.

Example 25 is the method of example 24, wherein indicating the beam shape information comprises outputting for transmission a MAC-CE or a DCI that includes a group identifier that indicates a configuration for the plurality of linked CSI reports and that includes the respective beam shape information for each respective set of resources that is associated with the respective linked CSI report.

Example 26 is the method of example 24, further comprising outputting for transmission a plurality of MAC-CEs or DCIs, each MAC-CE or DCI being associated with a respective linked CSI report and including the respective beam shape information for the respective set of resources that is associated with the respective linked CSI report.

Example 27 is the method of any of examples 15-26, further comprising selecting a beam shape associated with a TypeD-QCL source of an activated transmission configuration indicator (TCI) state as the beam shape information for a CMR set with a lowest periodicity of the one or more CMR sets.

Example 28 is the method of any of examples 15-27, wherein indicating the beam shape information comprises: outputting for transmission a MAC-CE configured to activate a TCI state; and updating a CMR set with a lowest periodicity of the one or more CMR sets to include a resource associated with a TypeD-QCL source of the activated TCI state.

Example 29 is an apparatus for wireless communication, comprising: a memory storing computer-executable instructions; and a processor configured to execute the instructions and cause the apparatus to perform the method of any of examples 1-14.

Example 30 is an apparatus for wireless communication, comprising: a memory storing computer-executable instructions; and a processor configured to execute the instructions and cause the apparatus to perform the method of any of examples 15-28.

Example 31 is a user equipment (UE), comprising: a transceiver; a memory storing computer-executable instructions; and a processor configured to execute the instructions and cause the UE to perform the method of any of examples 1-14, wherein the transceiver is configured to receive the configuration and transmit the CSI.

Example 32 is a base station, comprising: a transceiver; a memory storing computer-executable instructions; and a processor configured to execute the instructions and cause the base station to perform the method of any of examples 15-28, wherein the transceiver is configured to: transmit, to the UE, a configuration of the one or more CMR sets and virtual resources; transmit, to the UE, the beam shape information; and receive the CSI.

Example 33 is an apparatus for wireless communications, comprising means for performing a method in accordance with any one of examples 1-14.

Example 34 is an apparatus for wireless communications, comprising means for performing a method in accordance with any one of examples 15-28.

Example 35 is a non-transitory computer-readable medium comprising instructions that, when executed by an apparatus, causes the apparatus to perform a method in accordance with any one of examples 1-14.

Example 36 is a non-transitory computer-readable medium comprising instructions that, when executed by an apparatus, cause the apparatus to perform a method in accordance with any one of examples 15-28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An apparatus for wireless communication, comprising:
a memory storing computer-executable instructions; and
a processor configured to execute the instructions and cause the apparatus to:
obtain a configuration of one or more channel measurement resource (CMR) sets and virtual resources, wherein each of the one or more CMR sets has a unique measurement periodicity and the virtual resources are independent of any transmission of a reference signal thereon;
measure channel characteristics associated with the one or more CMR sets based on beam shape information and one or more of the unique measurement periodicities;
generate predicted channel characteristics associated with at least one of the virtual resources based on the beam shape information and the channel characteristics; and
report channel state information (CSI) comprising the channel characteristics and the predicted channel characteristics.

2. The apparatus of claim 1, wherein the beam shape information includes at least one of:
a beam pointing direction for a CMR or a virtual resource;
an angular-specific beamforming gain; or
an angular difference from a boresight direction for a specified beamwidth.

3. The apparatus of claim 1, wherein the processor is further configured to cause the apparatus to obtain a media access control (MAC) control element (CE) or a downlink control information (DCI) indicating the beam shape information.

4. The apparatus of claim 3, wherein at least one of:
the MAC-CE or the DCI includes a codepoint indication of a configured codebook of beam shapes to be associated with the one or more CMR sets and the virtual resources;
the MAC-CE or the DCI identifies a beam shape set associated with a CSI report, wherein the beam shape set associates the beam shape information with the one or more CMR sets and the virtual resources; or
the processor is further configured to cause the apparatus to report a recommended beam shape, wherein the MAC-CE or the DCI identifies the recommended beam shape previously reported by the apparatus.

5-6. (canceled)

7. The apparatus of claim 1, wherein to report the CSI the processor is further configured to cause the apparatus to output, for transmission, at least one CSI report including one or more of:
the channel characteristics associated with the one or more CMR sets corresponding to time domain occasions at which beams are received on the one or more CMR sets;
predicted channel characteristics associated with the one or more CMR sets corresponding to time domain occasions at which beams are not received on the one or more CMR sets; or
the predicted channel characteristics associated with the virtual resources on which no beam is received.

8. The apparatus of claim 7, wherein the at least one CSI report is a single CSI report associated with the beam shape information.

9. (canceled)

10. The apparatus of claim 7, wherein the at least one CSI report includes a plurality of linked CSI reports, each linked CSI report being associated with a respective set of resources and a respective beam shape information.

11-12. (canceled)

13. The apparatus of claim 1, wherein the processor is further configured to cause the apparatus to select a beam shape associated with a TypeD-QCL source of an activated transmission configuration indicator (TCI) state as the beam shape information for a CMR set with a shortest periodicity of the one or more CMR sets.

14. The apparatus of claim 1, wherein the processor is further configured to cause the apparatus to:
obtain a MAC-CE activating a TCI state; and
update a CMR set with a shortest periodicity of the one or more CMR sets to include a resource associated with a TypeD-QCL source of the activated TCI state.

15. An apparatus for wireless communication, comprising:
a memory storing computer-executable instructions; and
a processor configured to execute the instructions and cause the apparatus to:
configure a user equipment (UE) with one or more channel measurement resource (CMR) sets and virtual resources, wherein each of the one or more CMR sets has a unique measurement periodicity and the virtual resources are independent of any transmission of a reference signal thereon;
indicate beam shape information for the one or more CMR sets and the virtual resources; and
obtain channel state information (CSI) that includes measured channel characteristics associated with the one or more CMR sets and predicted channel characteristics associated with the virtual resources, wherein the predicted channel characteristics are based on the beam shape information and the measured channel characteristics.

16. The apparatus of claim 15, wherein the beam shape information includes at least one of:
a beam pointing direction for a CMR or a virtual resource;
an angular-specific beamforming gain; or
an angular difference from a boresight direction for a specified beamwidth.

17. The apparatus of claim 15, wherein to indicate the beam shape information, the processor is further configured to cause the apparatus to transmit a media access control (MAC) control element (CE) or a downlink control information (DCI) that indicates the beam shape information.

18. The apparatus of claim 17, wherein at least one of:
the MAC-CE or the DCI includes a codepoint indication of a configured codebook of beam shapes to be associated with the one or more CMR sets and the virtual resources;
the MAC-CE or the DCI identifies a beam shape set associated with a CSI report, wherein the beam shape set associates the beam shape information with the one or more CMR sets and the virtual resources; or
the processor is further configured to cause the apparatus to report a recommended beam shape, wherein the MAC-CE or the DCI identifies the recommended beam shape previously reported by the apparatus.

19-20. (canceled)

21. The apparatus of claim 15, wherein to obtain the CSI, the processor is further configured to cause the apparatus to obtain at least one CSI report including one or more of:
the measured channel characteristics associated with the one or more CMR sets corresponding to time domain occasions at which beams are transmitted on the one or more CMR sets;
predicted channel characteristics associated with the one or more CMR sets corresponding to time domain occasions at which beams are not transmitted on the one or more CMR sets; or
the predicted channel characteristics associated with the virtual resources on which no beam is transmitted.

22. The apparatus of claim 21, wherein the at least one CSI report is a single CSI report associated with the beam shape information.

23. (canceled)

24. The apparatus of claim 21, wherein the at least one CSI report includes a plurality of linked CSI reports, each linked CSI report being associated with a respective set of resources and a respective beam shape information.

25-26. (canceled)

27. The apparatus of claim 15, wherein the processor is further configured to cause the apparatus to select a beam shape associated with a TypeD-QCL source of an activated transmission configuration indicator (TCI) state as the beam shape information for a CMR set with a lowest periodicity of the one or more CMR sets.

28. The apparatus of claim 15, wherein to indicate the beam shape information, wherein the processor is further configured to cause the apparatus to:
output for transmission a MAC-CE configured to activate a TCI state; and
update a CMR set with a lowest periodicity of the one or more CMR sets to include a resource associated with a TypeD-QCL source of the activated TCI state.

29. The apparatus of claim 15, further comprising a transceiver configured to:
transmit, to the UE, a configuration of the one or more CMR sets and virtual resources;
transmit, to the UE, the beam shape information; and
receive the CSI, wherein the apparatus is configured as a base station.

30. A user equipment (UE), comprising:
a transceiver;
a memory storing computer-executable instructions; and
a processor configured to execute the instructions and cause the UE to:
receive, via the transceiver, a configuration of one or more channel measurement resource (CMR) sets and virtual resources, wherein each of the one or more CMR sets has a unique measurement periodicity and the virtual resources are independent of any transmission of a reference signal thereon;
measure channel characteristics associated with the one or more CMR sets based on beam shape information and one or more of the unique measurement periodicities;
generate predicted channel characteristics associated with at least one of the virtual resources based on the beam shape information and the channel characteristics; and
transmit, via the transceiver, channel state information (CSI) comprising the channel characteristics and the predicted channel characteristics.
